(19) United States
(12) Patent Application Publication
(10) Pub. No.: US 2021/0064596 A1
(43) Pub. Date: Mar. 4, 2021

(54) ENTRY TRANSACTION CONSISTENT DATABASE SYSTEM

(71) Applicant: AT&T Intellectual Property I, L.P., Atlanta, GA (US)

(72) Inventors: Bharath Balasubramanian, Princeton, NJ (US); Brendan Tschaen, Holmdel, NJ (US); Shankaranarayanan Puzhavakath Narayanan, Hillsborough, NJ (US); Zhe Huang, Princeton, NJ (US); Kaustubh Joshi, Scotch Plains, NJ (US); Richard D. Schlichting, Annapolis, MD (US); Enrique Jose Saurez Apuy, Atlanta, GA (US)

(21) Appl. No.: 16/557,632

(22) Filed: Aug. 30, 2019

(51) Int. Cl. G06F 16/23; G06F 16/27

(52) U.S. Cl. CPC G06F 16/2365; G06F 16/2379; G06F 16/27

(57) ABSTRACT

A processing system including at least one processor may provide a first instance of a plurality of instances of a database distributed at a plurality of different nodes, and a first instance of a plurality of instances of a middleware module distributed at the plurality of different nodes, the first instance of the middleware module associated with the first instance of the database. The first instance of the middleware module may be configured to receive a request from a first client to perform a transaction relating to a range of keys, confirm an ownership of the first client of the range of keys, execute operations of the transaction over the first instance of the database, and write a first entry to a first instance of an entry consistent store, the first entry recording a change of at least a value in the database resulting from executing the operations of the transaction.

The present disclosure relates generally to network edge computing, and more particularly to methods, computer-readable media, and apparatuses for providing a distributed database system with entry transactionality.

### BACKGROUND

Upgrading a telecommunication network to a software defined network (SDN) architecture implies replacing or augmenting existing network elements that may be integrated to perform a single function with new network elements. The replacement technology may comprise a substrate of networking capability, often called network function virtualization infrastructure (NFVI) that is capable of being directed with software and SDN protocols to perform a broad variety of network functions and services. Different locations in the telecommunication network may be provisioned with appropriate amounts of network substrate, and to the extent possible, routers, switches, edge caches, middle-boxes, and the like, may be instantiated from the common resource pool. In addition, where the network edge has previously been well-defined, the advent of new devices and SDN architectures are pushing the edge closer and closer to the customer premises and to devices that customers use on a day-to-day basis.

### SUMMARY

Methods, computer-readable media, and apparatuses for providing a distributed database system with entry transactionality are described. For instance, in one example, a processing system including at least one processor may provide a first instance of a database, the first instance of the database being one of a plurality of instances of the database distributed at a plurality of different nodes, and a first instance of a middleware module, the first instance of the middleware module being one of a plurality of instances of the middleware module distributed at the plurality of different nodes, where the first instance of the middleware module is associated with the first instance of the database. The first instance of the middleware module may be configured to receive a request from a first client to perform a transaction relating to at least one range of keys, confirm an ownership of the first client of the at least one range of keys, execute one or more operations of the transaction over the first instance of the database that is associated with the first instance of the middleware module, and write at least a first entry to a first instance of an entry consistent store, the at least the first entry recording at least one change of at least one value in the database resulting from executing the one or more operations of the transaction.

### BRIEF DESCRIPTION OF THE DRAWINGS

The teachings of the present disclosure can be readily understood by considering the following detailed description in conjunction with the accompanying drawings, in which:

FIG. 1 illustrates an example network, e.g., a distributed database system having an entry consistent store, in accordance with the present disclosure;

FIG. 2 illustrates a summary of main abstractions/functions provided by middleware (METRIC) processes/modules, in accordance with the present disclosure;

FIG. 3 illustrates an example use of middleware functions, in accordance with the present disclosure;

FIG. 4 illustrates a flowchart of an example method for providing a distributed database system with entry transactionality; and

FIG. 5 illustrates a high level block diagram of a computing device specifically programmed to perform the steps, functions, blocks and/or operations described herein.

To facilitate understanding, identical reference numerals have been used, where possible, to designate identical elements that are common to the figures.

### DETAILED DESCRIPTION

A geo-distributed database for edge architectures spanning thousands of sites should be able to assure efficient local updates while replicating sufficient state across sites to enable global management and support mobility, failover, and other features. Examples of the present disclosure provide a new paradigm for database clustering, referred to as entry transactionalty, which balances performance and strength of semantics. Entry transactionality guarantees that only a client that owns a range of keys in the database has a sequentially consistent value of the keys and can perform local, and hence efficient, transactions across these keys. Use cases enabled by entry transactionality, such as federated controllers and state management for edge applications are described in greater detail below. In addition, the semantics of entry transactionality incorporating failure modes in geo-distributed services are defined, and the challenges in realizing these semantics are outlined. Examples of the present disclosure include a middleware (which may be referred to as Middleware for Entry Transactional Clustering (METRIC)) that integrates Structured Query Language (SQL) database instances with an underlying geo-distributed entry consistent (EC) store to realize entry transactionality.

In accordance with the present disclosure, a geo-distributed database system may manage client and service state for edge architectures by efficiently updating local state, in addition to consistently replicating some or all of this state at other sites to enable global management and to support capabilities such as failover and mobility. In particular, the present disclosure provides a clustering middleware (METRIC) that balances performance and replication semantics through entry transactionality. Entry transactionality guarantees that only a database client that owns a range of keys: (a) has a sequentially consistent value of the keys at the time ownership is granted, and (b) can perform local and efficient transactions across these keys. Non-owners can read the state of the keys, but with no consistency guarantees.

In various database architectures, sharding may be used for horizontal scaling and performance. However, in accordance with the present disclosure the concept of key-ownership is elevated to an abstraction, rather than just in the underlying database implementation. Thus, METRIC enables service designers to construct services in a manner suited to geo-distribution. Further, since consistent replication and the complex failure modes of geo-distributed services are incorporated in the METRIC semantics, a service designer may only need to understand how state ownership transitions to suit the service. Realizing entry transactionality in a performant and correct manner involves addressing a conflict between efficiency and geo-replication. In particular, while the owner of a key range should be able to perform transactions efficiently, enough transaction state may also be geo-replicated to ensure that a potential new owner has access to consistent state, despite failures. To address this conflict, the present disclosure provides a lightweight clustering middleware (METRIC) over database instances (e.g., geo-distributed copies/instances of a SQL database).

In accordance with the present disclosure, a client can contact any METRIC process (broadly, a “middleware module”) deployed on a nearby site to acquire ownership of keys and perform transactions on the DB instance connected to that METRIC process. The DB instance serves as an efficient site level cache for each METRIC process and can be chosen according to production preferences for specific databases (such as MariaDB or PostgreSQL), with their in-built clustering mechanisms (if any) turned off. Consistent replication across sites is realized by storing data modified by each transaction in a multi-site entry consistent (EC) store. In accordance with the present disclosure the EC store implements the abstraction of a key-value store, with locking primitives that provide entry consistency, where sequential consistency is enforced only for the lock holder of a key. In addition, the middleware (METRIC) processes uses these abstractions to enforce ownership and to implement an entry consistent redo log, which offers improved performance and availability across sites as compared to geo-distributed databases that use a sequentially consistent commit/redo log across sites.

The geodistributed database system with entry transactionality of the present disclosure offers clients the abstraction of a replicated database with the additional notion of key ownership. In particular, the database system includes a set of middleware (METRIC) processes (or “modules”), where clients may issue requests to any METRIC process of its choice.

In accordance with the present disclosure, the database system includes a plurality of geo-distributed instances of a database, which maintains state in the form of an ordered range of unique keys, each with its own value. In one example, the database system may support a full suite of SQL operations. For instance, the “value” associated with each key may comprise a row with fields corresponding to columns, and which can be selected, searched, joined, etc., in accordance with a range of SQL commands. In one example, the semantics of replication is that a key has a single correct value determined by the rule “last write wins,” based on the timestamp associated with each write. The correct value eventually propagates to all replicas, assuming frequent enough communication.

A client can acquire ownership to a contiguous range of keys, or a key-range, at a middleware (METRIC) process, where it is guaranteed access to the sequentially consistent state of the keys in the key-range at that middleware (METRIC) process. In one example, a single client can be the owner of multiple non-overlapping key-ranges. In addition, in one example, any client can take ownership of a key-range belonging to another client at any time at any middleware (METRIC) process.

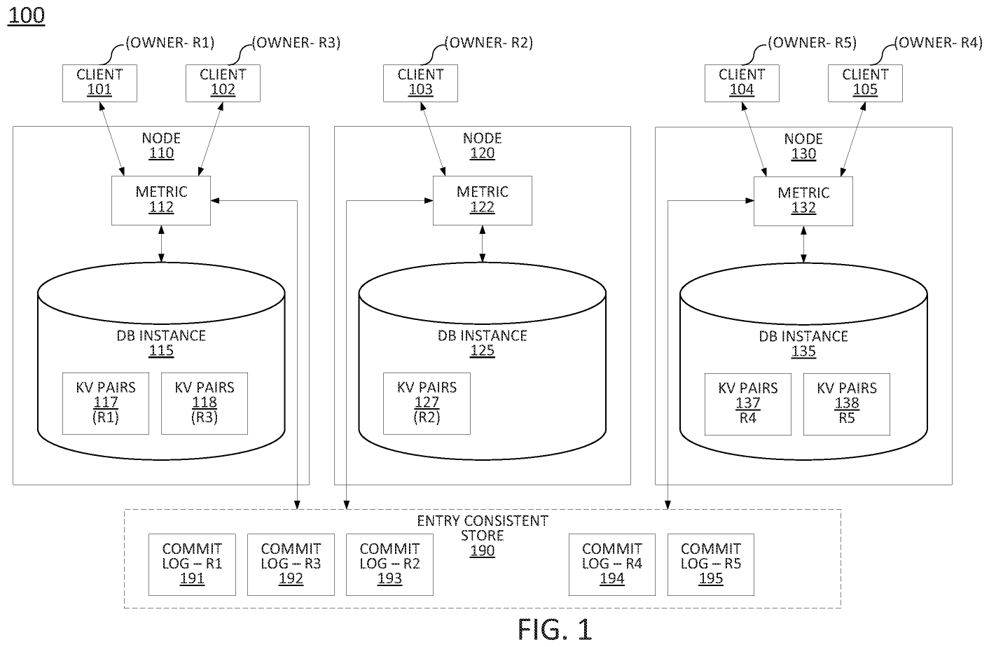

To aid in understanding the present disclosure, FIG. 1 illustrates an example system 100, e.g., a distributed database system with entry transactionality, in accordance with the present disclosure. As illustrated in FIG. 1, the system 100 includes middleware (METRIC) processes 112, 122, and 132 (or “middleware modules”), database instances 115, 125, and 135 (e.g., SQL database instances) associated with each METRIC process 112, 122, and 132, and an entry consistent (EC) store 190. The METRIC processes 112, 122, and 132 and the DB instances 115, 125, and 135 are deployed across multiple sites (e.g., nodes 110, 120, and 130) for locality, availability, and fault-tolerance. The nodes 110, 120, and 130 may comprise host devices, e.g., computing resources comprising processors, e.g., central processing units (CPUs), graphics processing units (GPUs), programmable logic devices (PLDs), such as field programmable gate arrays (FPGAs), or the like, memory, storage, and so forth. Thus, the nodes 110, 120, and 130 may comprise servers hosting virtualization platforms for managing one or more virtual machines (VMs), containers, microservices, or the like.

In one example, the nodes 110, 120, and 130 may comprise network function virtualization infrastructure (NFVI), e.g., for software defined network (SDN) services of a telecommunications network operator, such as virtual mobility management entities (vMMEs), virtual serving gateways (vSGWs), virtual packet data network gateways (vPDNGWs or VPGWs) or other virtual network functions (VNFs). In such an example, nodes 110, 120, and/or 130 may provide middleware (METRIC) processes in addition to other applications/services. For instance, clients 102, 103, and 104 may comprise VNFs functioning as local SDN controllers, vMMEs, vSGWs, video servers, gaming servers, translation servers, etc. which may be logically separated from the middleware (METRIC) processes 112, 122, and 132, respectively. In another example, nodes 110, 120, and 130 hosting a distributed database system with entry transactionality may be physically separate from any nodes (e.g., host devices/NFVI) hosting VMs, VNFs, or the like for providing other services.

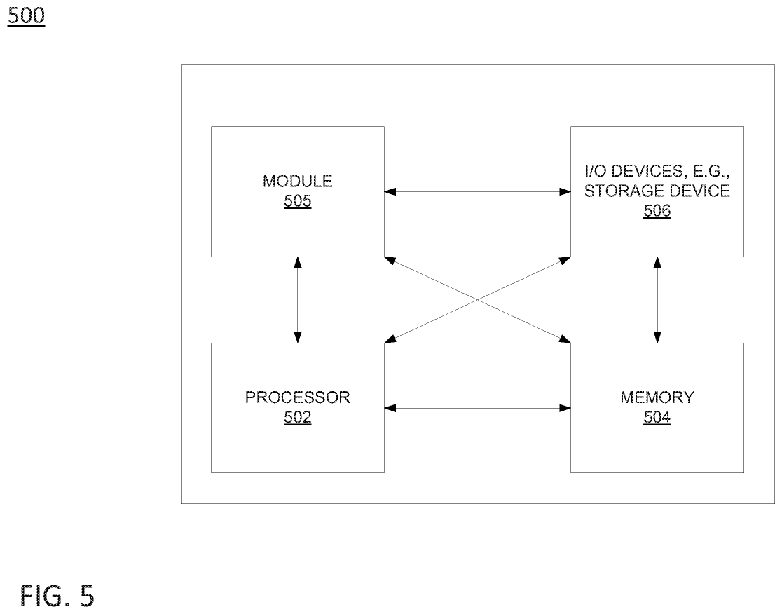

In one example, each of nodes 110, 120, and 130 may comprise a computing system or server, such as computing system 500 depicted in FIG. 5, and may be configured to provide one or more operations or functions in connection with examples of the present disclosure for providing a distributed database system with entry transactionality, as described herein (e.g., in accordance with the example method 400). It should be noted that as used herein, the terms “configure,” and “reconfigure” may refer to programming or loading a processing system with computer-readable/computer-executable instructions, code, and/or programs, e.g., in a distributed or non-distributed memory, which when executed by a processor, or processors, of the processing system within a same device or within distributed devices, may cause the processing system to perform various functions. Such terms may also encompass providing variables, data values, tables, objects, or other data structures or the like which may cause a processing system executing computer-readable instructions, code, and/or programs to function differently depending upon the values of the variables or other data structures that are provided. As referred to herein a “processing system” may comprise a computing device including one or more processors, or cores (e.g., as illustrated in FIG. 5 and discussed below) or multiple computing devices collectively configured to perform various steps, functions, and/or operations in accordance with the present disclosure.

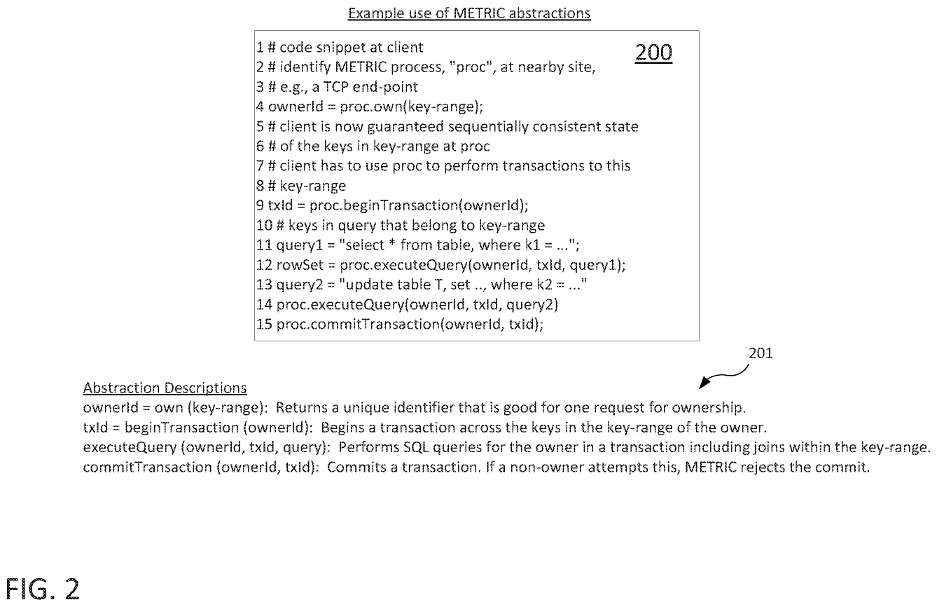

The METRIC processes 112, 122, and 132 provide an interface to clients (e.g., clients 101-105) that can be accessed through advertised end-points (e.g., a TCP/REST endpoint) and that implement the abstractions/functions described in greater detail below and additionally illustrated in FIG. 2. Each METRIC process 112, 122, and 132 is stateless in that it maintains all state in the respective associated DB instances 115, 125, or 135 and the EC store 190. In the example of FIG. 1, each METRIC process 112, 122, and 132 is strictly associated with a respective DB instance 115, 125, or 135 that is used to execute transactions for clients that own key ranges at that METRIC process. For instance, in the example of FIG. 1, client 101 is owner of key range R1 via METRIC process 112, and client 102 is owner of key range R3 via METRIC process 112. Accordingly, client 101 may perform, at DB instance 115, write operations on key-value (KV) pairs 117 with keys in the key range R1, while client 102 may perform, at DB instance 115, write operations on KV pairs 118 with keys in the key range R3. Similarly, client 103 may be owner of key range R2 via METRIC process 122 and may perform, at DB instance 125, write operations on KV pairs 127 in the key range R2. Client 104 may be owner of key range R5 via METRIC process 132 and may perform, at DB instance 135, write operations on KV pairs 138 in the key range R5. In addition, client 105 may be owner of key range R4 via METRIC process 132 and may perform, at DB instance 135, write operations on KV pairs 137 in the key range R4.

In one example, it is assumed that the database (embodied as multiple DB instances 115, 125, 135, etc.) supports ACID (atomicity, consistency, isolation, durability) transactions with serializable level of isolation. Moreover, the database is assumed to be purely local to each METRIC process 112, 122, and 132, and not clustered across sites. In other words, each site and/or node 110, 120, or 130 includes a separate instance/copy of the database (DB instances 115, 125, and 135). However, to load balance and account for failures, a DB instance may be clustered within a site and/or a node, as long as the site and/or the node provides the abstraction of a single transactional database to the METRIC process with which the DB instance is associated. For example, a METRIC process can be connected to a three-node MariaDB-Gallera cluster deployed within a site and/or a node, as opposed to a single MariaDB instance.

In one example, the EC store 190 may comprise a MUSIC (MUlti-Site entry Consistency) key-value store. The EC store 190 provides the abstraction of a replicated key-value store where clients 101-105 can acquire a lock to a key and be guaranteed a sequentially consistent value of this key. When the lock holder/owner performs reads and writes to the value associated with the key, other clients are excluded from write operations. However, for the lock holder/owner, the operations are sequentially consistent so that all reads and writes are totally ordered. Notably, the EC store 190, e.g., a MUSIC key-value store, limits the use of distributed consensus to entry and exit of ownership, and implements reads and writes using more efficient quorum operations across an underlying eventually consistent store. While other geo-distributed databases may implement a commit/redo log on top of a sequentially-consistent store, the present disclosure implements a redo log on top of an entry-consistent store, which provides improved performance for geo-distributed sites due to its limited use of consensus. With a geo-distributed redo log (and associated data structures) (e.g., MUSIC), upon ownership transition, a new owner may have access to the sequentially consistent state of the key range at the DB instance that is paired with the METRIC process that granted ownership.

It should be noted that in various examples, the entry consistent (EC) store 190 may be replicated in the system 100 as a plurality of distributed EC stores, e.g., with distributed consensus for entry and exit of ownership, and with eventual consistency of redo/commit logs. However, it should also be noted that the ratio of EC store instances to middleware (METRIC) processes and DB instances is not necessarily 1:1. For instance, the ratio of EC stores to middleware (METRIC) processes and DB instances may comprise 1:2, 1:4, 1:16, etc. In addition, in such examples, the EC store instances are not necessarily located at the same nodes or locations, and/or hosted on the same host devices/NFVI as the nodes 110, 120, or 130.

The semantics of the middleware module/process (e.g., METRIC) may include several functions which are described as follows (additional descriptions of the abstractions/functions are contained in FIG. 2). A first function of METRIC is the “own” function: own (key-range). In one example, each key-range with an owner is represented by a unique range-owner-key “own (key-range)” in the EC store 190 (e.g., a MUSIC EC store), with a value pointing to the MUSIC table that is the redo log for that range/owner combination (e.g., one of commit logs 191-195, each corresponding to one of key ranges R1-R5, respectively). Each range-owner-key is associated with a lock, where the unique id of that lock is the ownerId. When a client (e.g., one of clients 101-105) requests ownership of a range from a middleware (METRIC) process (e.g., one of METRIC processes 112, 122, or 132), the middleware (METRIC) process may first release all locks that have key ranges that overlap with the requested range. The middleware (METRIC) process may then create a new range-key corresponding to the requested range and acquire a lock to this range, creating a new ownerId.

At this point, the middleware (METRIC) process is guaranteed that no other client can modify the keys in the requested range by virtue of MUSIC's locking semantics. In addition, the middleware (METRIC) process can read the redo logs of all the keys in the requested range from the EC store 190 (MUSIC) and populate the local instance of the database associated with the middleware (METRIC) process. The middleware (METRIC) process may thereby provide the owner of the key range with the sequentially consistent value(s) of these keys at the middleware (METRIC) process. Note that this function may be used by clients 101-105 both to acquire ownership during initialization and during a transition, either voluntarily or on detecting a client failure.

To grant ownership and populate the consistent value(s) of the keys in a local DB instance (e.g., one of DB instances 115, 125, or 135), a middleware (METRIC) process (e.g., one of METRIC processes 112, 122, or 132) uses both distributed consensus for lock transitions in the EC store 190 and quorum operations (to read the latest redo log state) across sites (e.g., nodes 110, 120, and 130). Hence, this is a relatively expensive operation, and in one example may be invoked infrequently. However in many use cases, ownership transition is the exception rather than the norm. Additionally, the cost can be reduced and amortized by prefetching the corresponding data into nodes where there is an expectation of ownership.

Another function of METRIC is the “beginTransaction” function: beginTransaction (ownerId). A middleware (METRIC) process (e.g., one of METRIC processes 112, 122, or 132) may first ensure that an ownerId is indeed the owner for the key range. If true, the middleware (METRIC) process may then create a unique transaction id for this transaction via the beginTransaction function. Further, the beginTransaction function may create a shadow table in the local instance of the database to track the operations in this transaction.

Another function of METRIC is the “executeQuery” function: executeQuery (ownerId, txId, query). After confirming that the ownerId of the query is the owner (own (key-range)), and beginning the transaction (beginTransaction) a middleware (METRIC) process (e.g., one of METRIC processes 112, 122, or 132) may execute the query at the local DB instance (e.g., one of DB instances 115, 125, or 135) and create an entry in the shadow table with the old and new value(s) of the key(s) after the query executes. Note that in one example, since an owner of a key range issues queries to the same middleware (METRIC) process and hence the same DB instance, ACID semantics is guaranteed. Further, any joins, which are only supported within the key range of the owner, do not involve cross-site operations since all the queries are executed locally.

A further function of METRIC is the “commitTransaction” function: commitTransaction (ownerId, txId). A middleware (METRIC) process (e.g., one of METRIC processes 112, 122, or 132) may first create a concise digest of all the old and new values modified by a transaction (physical logging), which may be regularly maintained in the shadow table of the local DB instance (e.g., one of DB instances 115, 125, or 135) during query execution. The middleware (METRIC) process may then append the digest to the redo/commit log in the EC store 190 created specifically for the owner (e.g., one of commit logs 191-195) using cross-site quorum operations.

It should be noted that the system 100 may be implemented over one or more networks having various underlying components and using various technologies. For instance, the system 100 may be deployed over a telecommunication network which may include a core network, various access networks, and so forth. For example, the system 100 may be part of a telecommunication network that combines core network components of a cellular network with components of a triple play service network; where triple-play services include telephone services, Internet services and television services to subscribers. For example, the telecommunication network may functionally comprise a fixed mobile convergence (FMC) network, e.g., an IP Multimedia Subsystem (IMS) network. In addition, the telecommunication network may functionally comprise a telephony network, e.g., an Internet Protocol/Multi-Protocol Label Switching (IP/MPLS) backbone network utilizing Session Initiation Protocol (SIP) for circuit-switched and Voice over Internet Protocol (VoIP) telephony services. The telecommunication network may further comprise a broadcast television network, e.g., a traditional cable provider network or an Internet Protocol Television (IPTV) network, as well as an Internet Service Provider (ISP) network. In one example, a telecommunication network in which the system 100 is deployed may include access networks comprising Digital Subscriber Line (DSL) networks, public switched telephone network (PSTN) access networks, broadband cable access networks, Local Area Networks (LANs), wireless access networks (e.g., an Institute for Electrical and Electronics Engineers (IEEE) 802.11/Wi-Fi network and the like), cellular access networks, 3^{rd} party networks, and the like. For example, the operator of the telecommunication network may provide a cable television service, an IPTV service, or any other types of telecommunication service to subscribers.

FIG. 2 includes a summary 201 of the main abstractions/functions provided by the middleware (METRIC) processes/modules. As further depicted in FIG. 2, the algorithm 200 (e.g., set forth in pseudocode) illustrates the use of the functions through an example of a client accessing a middleware (METRIC) process to own a key-range and perform transactions on the values of the key-range. For instance, in accordance with the algorithm 200, a client that intends to perform transactions across a range of keys may first identify a middleware (METRIC) process (“proc”) which may be located at a nearby site for performance reasons. The client may then use the “own” function to acquire ownership over a range of keys (e.g., line 4 of algorithm 200). The function may return a globally unique identifier “ownerId” (e.g., a universally unique identifier (UUID)) that is used by the middleware (METRIC) process to identify the owner for a range of keys. On acquiring ownership, the client is guaranteed the latest value of the keys in the range at “proc” and can now perform transactions within that range. In one example, the client may first initialize the middleware (METRIC) process to begin one or more transactions in the key range (e.g., line 9). For instance, the beginTransaction function may result in the assignment of a transaction identifier and a creation of a shadow table at the local DB instance by the middleware (METRIC) process. Then, the client may use an interface to SQL transactions provided by the middleware (METRIC) process to begin, execute, and commit queries during a transaction (e.g., lines 11-14). It should be noted that the client may include its ownerId (e.g., line 14) so that the middleware (METRIC) process can verify that the client is indeed the owner of the key range. It should also be noted that one of the features of the middleware (METRIC) abstractions (or “functions”) is that the client can use the functions to acquire ownership of a key range from another client, either voluntarily or on detecting failure of the client, in a manner as shown in the algorithm 200.

Two use cases for entry transactionality relating edge services include (1) federated state management and (2) ownership transition across edge service replicas triggered by mobility, load-balancing, or failure. For instance, a telecommunication network employing a software defined network (SDN) infrastructure may include federated SDN controllers for managing virtual network function (VNF) deployment across edge sites. For example, an edge software stack may be deployed on telecommunication network edge sites, and may host various edge services such as virtualized radio access network (RAN) components for 5G deployments, services for deep learning and augmented reality, and so forth. In one example, a control plane for edge services may comprise a federation of regional controllers, each of which may manage hundreds of edge sites. Each edge site may have a local controller that may typically perform transactions on the state of the edge site to which it assigned, while allowing regional controllers to perform occasional transactions across the state of the edge sites in different regions to enforce global actions.

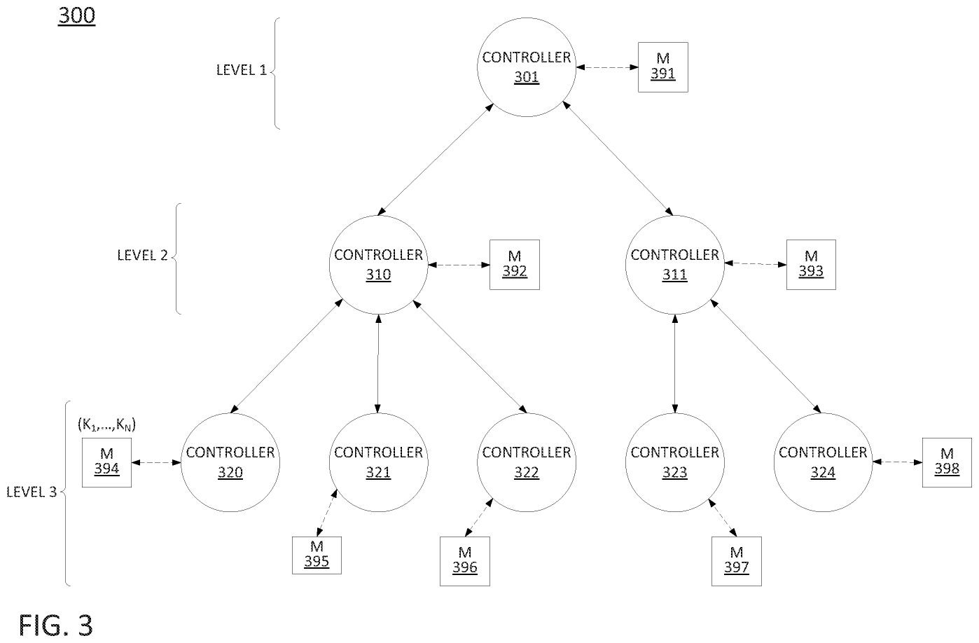

An example network 300 of federated SDN controllers is illustrated in FIG. 3. In this example, there are three levels of SDN controllers (levels 1-3). Level 1 includes a global SDN controller, controller 301. Level 2 includes regional SDN controllers, e.g., controllers 310 and 311, subordinate to the global SDN controller, controller 301. Level 3 includes local SDN controllers, e.g., controllers 320-324, subordinate to the regional SDN controllers of Level 2. In this example, each regional controller 310-311 may receive deployment specifications of VNFs from the global controller 301 and may identify appropriate edge sites (e.g., edge sites that satisfy the VNF's constraints on locality, specific hardware, etc.) across which one or more of the components of the VNF (such as virtual machines (VMs), containers, microservices, etc.) may be deployed. A local controller at each edge site (e.g., controllers 320-324, respectively) may then perform the actual role of placing the VMs of the VNF on the hosts of the edge site.

In one example, each of the local controllers 320-324 may also manage the state of resources as the respective edge site in a transactional database to ensure optimal and correct placement. In addition, in one example, the regional controllers 310 and 311 may periodically read the state of the resources across edge sites to track usage. For certain VNFs that require strict performance guarantees, the regional controllers 310 and 311 may reserve resources at the edge site(s) to ensure that these requirements are adequately satisfied at deployment time. For instance, one of the regional controllers 310 or 311 may instruct one of the local controllers 320-324 to reserve edge resources (e.g., NFVI, host devices, etc.). In accordance with the present disclosure, a geodistributed database system with entry transactionality may be used to satisfy the state management requirements of the network 300. Specifically, the regional controllers 310 and 311, and local controllers 320-324 can all share a multi-site (geodistributed) database system with entry transactionality, where the local controllers 320-324 maintain their resource states in the DB instance of a nearby middleware process (M 391-398), acquire ownership of these states, and issue transactions over the local DB instances paired with respective middleware processes M 391-398 during VNF and/or VM deployment.

In operation, regional controllers 310 and 311 (non-owners) may read the state of these local resources from any middleware (METRIC) process M 391-398. To reserve resources, the use of one of the middleware (METRIC) processes M 391-398 enables a regional controller 310 or 311 to acquire ownership of the state of one or more local controllers 320-324 managed by the regional controller 310 or 311, to read the sequentially consistent state(s) of the resources, and to then update the state(s) in a transactional manner. In various examples, a distributed database system of the present disclosure with entry transactionality may perform state management for various functions such as authentication and closed-loop control in a federated manner across local and regional controllers.

It should be noted that the network 300 may comprise various additional components that are omitted from illustration in FIG. 3. For instance, as mentioned above, a distributed database system with entry transactionality may be deployed in a telecommunication network having various components for telephony, television, and other data services. In addition, the network 300 may further comprise a geodistributed entry consistent (EC) store, which may comprise one or more copies/instances of such an EC store.

As mentioned above, in one example, any client can take ownership of a key-range belonging to another client at any time at any middleware (METRIC) process. For example, in FIG. 3, while local controller 320 is usually the owner for the key range (k₁, . . . , k₁₀) that it maintains at middleware (METRIC) process M 394, when regional controller 310 wants ownership for this range, the regional controller 310 can communicate with a closer middleware (METRIC) process M 392 to obtain the latest values of the keys.

While it has no implications on correctness, examples of the present disclosure may be most efficient in cases where transfer of ownership is relatively rare with minimal contention. For instance, in the example of federated controllers maintaining VNF state, there may generally be one or two clients that want ownership of a key-range. In addition, one of the clients may seek ownership relatively infrequently (e.g., a regional controller). Accordingly, in one example, the present disclosure may omit an arbitration mechanism across clients seeking ownership. However, in other, further, and different example, explicit or implicit signaling may be provided among clients to decide which client should be the new owner. For example, in the case of federated SDN controllers, a regional controller may explicitly send a message to a local controller to coordinate ownership. The regional controller may then contact a middleware process for ownership of the local state(s). In the case of an edge mobility application/service, when an end user moves from one service replica to another, the new service replica may request and obtain ownership of the end user's state with the implicit knowledge that the old service replica no longer needs ownership.

As mentioned above, in the present examples, only the owner of a key-range is permitted to write to the keys in a key-range (e.g., to write or change the value(s) associated with the key(s)). The write operations may include addition, deletion, and SQL-style joins of keys in the range. For both reads and writes an owner may send a request to the middleware (METRIC) process that granted ownership to the key-range. The owner is guaranteed ACID (atomicity, consistency, isolation, durability) transactional semantics with serializable isolation for all reads and writes to the keys in the key-range. Hence, in the example of FIG. 3, if local controller 320 (e.g., a “client”) obtains ownership of (k₁, . . . , k₁₀) at middleware process M 394, then controller 320 issues transactions to this key-range at this middleware process m 394. Non-owners can read (potentially inconsistent) values of any key at any middleware (METRIC) processes 391-398.

If a client does not receive a response to an ownership request at a middleware (METRIC) process, the client may assume the middleware (METRIC) process has failed and may send the request to a different middleware (METRIC) process. Similarly, if the owner (client) of a key-range does not receive a response for an operation within a transaction from the middleware (METRIC) process, the owner may assume that the middleware (METRIC) process has failed and may re-request ownership of the key-range at some other middleware (METRIC) process. The owner may then retry the aborted transaction at the new middleware (METRIC) process. For instance, in the example of FIG. 3, if local controller 320 does not receive a response for a certain query in a transaction to a key in (k₁, . . . , k₁₀) at middleware (METRIC) process M 394, the local controller 320 may acquire ownership of this key range at another middleware (METRIC) process, such as middleware (METRIC) process M 395, and retry the entire transaction. In one example, client failures may be detected using timeouts by other clients (e.g., in a federated SDN controller architecture). In addition, in one example, If a first client detects the failure of a second client, the first client may acquire ownership of some or all of the keys owned by the second client and perform transactions on the keys (e.g., writing to the values associated with the keys). If a client loses ownership of its keys to another client due to erroneous failure detection, then the operations of the original owner/client may fail, thereby informing the original owner/client that ownership has transitioned. In one example, if a client loses ownership of even a single key in a key-range, the client loses ownership to all the keys in that key-range.

As mentioned above, a geodistributed database system with entry transactionality may also be deployed to support ownership transition across edge services. Notably, providing computing infrastructure at or near the edge of a telecommunication network enables applications to provide or expand low-latency services to end users. For example, an object recognition service that performs deep learning may benefit from having all or a portion of the network-based/server-based computing being performed in an edge cloud, e.g., as compared to a centralized cloud or public cloud at a remote site. In one example, such a service may be deployed with replicas at multiple edge sites (e.g., across a country, worldwide, etc.). Each service replica may maintain various aspects of a state corresponding to an end user associated with that service replica (e.g., a catalog of objects, mobility history, session state, account details, and so on). In one example, an end user associated with a service replica may be transitioned to a different service replica. For example, this event may be triggered by the service to handle the failure of the old service replica, to load balance among replicas, to account for the user moving from one location to another, and/or to satisfy latency requirements.

The new service replica should have access to the latest state of the user and may continue modifying this state as it serves the end user. In accordance with the present disclosure, user state may be maintained via a geodistributed database system with entry transactionality where each service replica acquires ownership of the state(s) of the users associated with the service replica, either at initialization or triggered by a transition. In contrast, fully transactional database systems (e.g., MariaDB, CockroachDB, etc.) suffer from the performance implications described above (e.g., for a nationwide deployment). In addition, asynchronous PostgreSQL replication is insufficient to address the above scenarios since these use cases often require stronger guarantees. Prior solutions may maintain independent database clusters for different components—for example, a cluster for edge sites in a city and a cluster for each regional controller. To obtain a federated view of shared state or to allow for transition, these systems may require complex handwritten code that migrates state between the database clusters. This not only increases system complexity, but is also prone to errors, particularly during migration.

The entry transactionality of the present disclosure hides such complexity from the system designer, who may only need to understand how state ownership transitions, where the underlying data semantics are guaranteed by the middleware (METRIC) processes. For instance, the present distributed database system with entry transactionality comprises a plurality of middleware modules (METRIC processes) and database instances that communicate using messages over a network. In one example, to overcome the challenges of distributed consensus in asynchronous systems, the present disclosure assumes partial synchrony to achieve consensus, e.g., where there are sufficient periods of communication synchrony with an upper bound on message delay. Notably, processes can suffer crash failures, which implies that a peer middleware process may insufficiently distinguish between a failed process and one that is slow to respond and/or unable to communicate. The latter may occur in geo-distributed systems where failures in communication links can isolate a process from other processes in the system.

Examples of the present disclosure may use other backend stores internally, where at least a quorum of the processes of these backend stores are always available. For example, the present disclosure maintains client key-value pairs in a geo-distributed EC store (e.g., a MUSIC EC store), which guarantees that data is replicated for both fault tolerance and availability in at least a quorum of its processes. In one example, aspects of the present disclosure may be deployed as a drop-in replacement for the clustering mechanisms in existing databases, such as MySQL and PostgreSQL, to support production preferences. While geo-distributed sharded databases also need to replicate data consistently across sites, solutions using a sequentially consistent cross-site commit log suffer from the fact that each commit operation to the log incurs the cost of distributed consensus across sites. Some examples further utilize a global sequencer to order operations, which also incurs a heavy penalty across sites.

Examples of the present disclosure provide features of a SQL database to provide transactionality to an owner of a key range as a local cache, while using an entry consistent (EC) store to ensure exclusive access to the owner of a key-range and to maintain a geo-distributed redo log that is replicated across sites with entry-consistent semantics. In one example, the use of distributed consensus across sites is limited to the case of ownership transition. In one example, each query in a transaction is a local SQL database operation, where transaction state is updated when committing a transaction using quorum operations to the redo/commit log in the EC store. A failure is handled essentially as an ownership transition, thereby combining two aspects of entry transactionality and making it easier to reason about correctness.

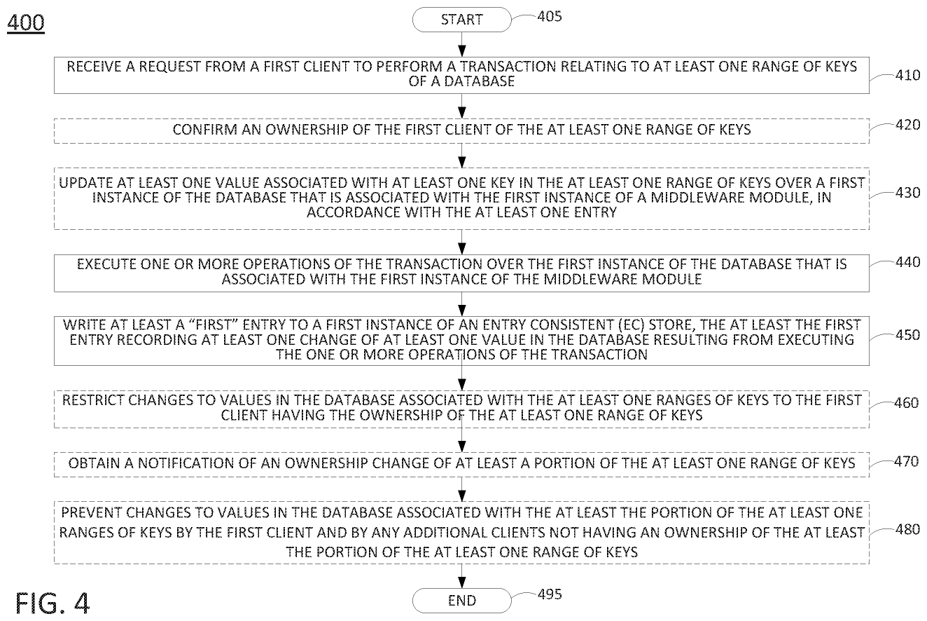

FIG. 4 illustrates a flowchart of an example method 400 for providing a distributed database system with entry transactionality, in accordance with the present disclosure. In one example, the method 400 is performed by the system 100 of FIG. 1, or by one or more components thereof, such as one of nodes 110, 120, or 130, middleware (METRIC) processes 112, 122, or 132 operating thereon, (e.g., a processor, or processors, performing operations stored in and loaded from a memory), EC store 190, and so forth. In one example, the steps, functions, or operations of method 400 may be performed by a computing device or system 500, and/or processor 502 as described in connection with FIG. 5 below. For instance, the computing device or system 500 may represent any one or more components of the system 100 that is/are configured to perform the steps, functions and/or operations of the method 400. Similarly, in one example, the steps, functions, or operations of method 400 may be performed by a processing system comprising one or more computing devices collectively configured to perform various steps, functions, and/or operations of the method 400. For instance, multiple instances of the computing device or processing system 500 may collectively function as a processing system. For illustrative purposes, the method 400 is described in greater detail below in connection with an example performed by a processing system. The method 400 begins in step 405 and proceeds to step 410.

At step 410, the processing system receives a request from a first client to perform a transaction relating to at least one range of keys of a database. The processing system may include at least one processor to provide a first instance of a middleware module, where the first instance of the middleware module is one of a plurality of instances of the middleware module distributed at a plurality of different nodes. In one example, the first instance of the middleware module is associated with a first instance of the database, where a plurality of instances of the database is distributed at the plurality of different nodes. In addition, in one example, the processing system also provides the first instance of the database. For instance, the processing system may further include at least one storage device, to store the first instance of the database. In other words, the processing system may comprise a node, or at least a portion thereof. Similarly, the plurality of different nodes is distributed at a plurality of different sites and may comprise various computing resources, including processors, memory, storage devices, and so forth.

In one example, the database comprises a structured query language (SQL) database, e.g., a database that is accessible and manipulable via SQL queries. In one example, the database may comprise a plurality of rows, each row comprising a key and a value. For example, the “value” of each row may comprise one or more fields, where each of the one or more fields is selectable via a structured query. In other words, each of the “fields” may be associated with a different column of the database. In one example, the at least one range of keys is associated with at least one partition of the database. For instance, in one example, the database may be horizontally partitioned, or “sharded” and the key ranges that are selectable for ownership may correspond to the partitions.

In one example, the first client is one of a plurality of clients that is permitted to access the database. In addition, in one example, the plurality of clients comprises a plurality of federated software defined network (SDN) controllers. For instance, the database (e.g., the plurality of instances thereof) stores information associated with a plurality of virtual network functions (VNFs) of a telecommunication network.

At step 420, the processing system confirms an ownership of the first client of the at least one range of keys. In one example, step 420 may be in accordance with an abstraction/function of the middleware module, such as illustrated in line 4 of the example algorithm 200 of FIG. 2.

At optional step 430, the processing system may obtain at least one entry (e.g., at least a “second” entry) relating to the at least one range of keys from a first instance of an entry consistent (EC) store, in response to receiving the request from the first client to perform the transaction relating to the at least one range of keys. For instance, the entry may comprise an entry in a commit/redo log that is associated with keys in the range of keys. It should also be noted that although the terms, “first,” “second,” “third,” etc., may be used herein, the use of these terms are intended as labels only. Thus, the use of a term such as “third” in one example does not necessarily imply that the example must in every case include a “first” and/or a “second” of a similar item. In other words, the use of the terms “first,” “second,” “third,” and “fourth,” do not imply a particular number of those items corresponding to those numerical values. In addition, the use of the term “third” for example, does not imply a specific sequence or temporal relationship with respect to a “first” and/or a “second” of a particular type of item, unless otherwise indicated.

At optional step 430, the processing system may update at least one value associated with at least one key in the at least one range of keys over the first instance of the database that is associated with the first instance of the middleware module, in accordance with the at least one entry (e.g., the at least the “second” entry). For instance, optional steps 420 and 430 may relate to the processing system first ensuring that the values associated with the keys in the at least one range of keys are updated to the correct values in the first instance of the database prior to engaging in any transactions (or any operations thereof) for the first client.

At step 440, the processing system executes one or more operations of the transaction over the first instance of the database (the “local” DB instance) that is associated with the first instance of the middleware module. For example, step 440 may comprise operations in accordance with an abstraction/function of the middleware module, such as those set forth in lines 11-14 of the example algorithm 200 of FIG. 2. For instance, the first instance of the middleware module (as well as other instances) may provide clients with access to a suite of SQL operations. For instance, the “value” associated with each key may comprise a row with fields corresponding to columns, and which can be selected, searched, joined, etc., in accordance with various SQL commands.

At step 450, the processing system writes at least a “first” entry to a first instance of an entry consistent (EC) store, the at least the first entry recording at least one change of at least one value in the database resulting from executing the one or more operations of the transaction. For example, step 450 may comprise one or more operations in accordance with an abstraction/function of the middleware module such as that which is set forth in line 15 of the example algorithm 200 of FIG. 2.

In addition, the processing system (e.g., providing the first instance of the middleware module) may maintain sequential consistency of operations with respect to the at least one range of keys within the first instance of the database that is associated with the first instance of the middleware module, e.g., during a time of ownership of the at least one range of keys by the at least the first client. For instance, subsequent entries may be made to the first instance of the EC store in connection with subsequent transactions (e.g., one or more queries) and may be stored sequentially in a redo/commit log for the first client/owner pertaining to the range of keys.

In one example, the first instance of the EC store is one of a plurality of instances of the EC store. For example, the plurality of instances of the EC store may maintain entries comprising changes in values in the database resulting from execution of operations of transactions via the plurality of middleware modules. For instance, the plurality of instances of the EC store may maintain commit/redo logs for key ranges. Owners may submit transactions to a commit/redo log at a local instance of the EC store, which may eventually propagate new entries to the commit/redo log (and/or to a plurality of commit/redo logs) to other instances of the EC store. In addition, each instance of the EC store may obtain updates to other commit/redo logs from other instances of the EC store. For example, instances of the EC store may periodically send commit/redo log updates, may obtain commit/redo log updates from peer EC store instances on demand, e.g., when a new client/owner seeks to obtain ownership of a key range, and so forth. Thus, the plurality of EC stores enables an eventual consistency for instances of the database distributed at the plurality of different nodes of the database system.

In one example, the number of instances of EC store may be less than the number of nodes, the number of instances of the middleware module, and the number of instances of the database. In addition, the instances of the EC store may or may not be deployed at a node having an instance of the database and an instance of the middleware module. Thus, in one example, the processing system may further include at least one memory unit, to provide the first instance of the EC store (in this case, the first instance of the EC store is part of the processing system and/or the node including the processing system, and not separate from it). In still another example, the database may be associated with one central copy of the EC store, in which case, the “first instance” of the entry consistent store may be the sole “instance” of the EC store.

At optional step 460, the processing system may restrict changes to values in the database associated with the at least one ranges of keys to the first client having the ownership of the at least one range of keys. In addition, in one example, each of the plurality of instances of the middleware module is configured to prevent changes to values in the database associated with the at least one ranges of keys by clients other than the first client having the ownership of the at least one range of keys. In addition, in one example, the middleware modules (other than the first) may disallow any changes to values associated with range of keys (since first client is registered via the first middleware module, and is not accessing the DB instances via any other of the plurality of middleware modules).

At optional step 470, the processing system may obtain a notification of an ownership change of at least a portion of the at least one range of keys. In one example, the notification of the ownership change is obtained from a different one of the plurality of instances of the middleware module. Alternatively, or in addition, the processing system may obtain the notification of the ownership change from the first instance of the EC store. For example, a different instance of the EC store may notify the first instance of the EC store of a change in ownership.

At optional step 480, the processing system may prevent changes to values in the database associated with the at least the portion of the at least one ranges of keys by the first client and by any additional clients not having an ownership of the at least the portion of the at least one range of keys. In addition, in one example the first instance of the EC store may then reject any additional updates to the commit/redo log for the at least the first key range for the first client (now no longer the owner). For example, in the event that the processing system (e.g., the first instance of the middleware module) does not receive the notification of the ownership change from a peer instance of the middleware module, the first instance of the EC store may block changes by the first client (and others) to the commit/redo log associated with the at least the one range of keys to maintain system-wide consistency, where only the new owner is permitted to write to a commit/redo log associated with the at least the first key range at the same or a different EC store.

Following step 450 or any one or more of optional steps 460-480 the method 400 proceeds to step 495 where the method ends.

It should be noted that the method 400 may be expanded to include additional steps, or may be modified to replace steps with different steps, to combine steps, to omit steps, to perform steps in a different order, and so forth. For instance, in one example the processing system may repeat one or more steps of the method 400, such as steps 410, 420, 440, and 450, or steps 410-480, and so forth. In another example, the at least one entry (e.g., the at least the “second” entry) relating to the at least one range of keys may be obtained at optional step 430 from a different instance of the EC store. For example, the first instance of the EC store may be collocated with and/or the closest to the node and/or the first instance of the middleware module. However, the first instance of the EC store may be unavailable due to network conditions, excessive traffic, etc. As such, the processing system (e.g., the first instance of the middleware module) may contact another instance of the EC store to obtain the information to verify and to update the current value(s) associated with the keys in the at least one range of keys. Thus, these and other modifications are all contemplated within the scope of the present disclosure.

In addition, although not expressly specified above, one or more steps of the method 400 may include a storing, displaying and/or outputting step as required for a particular application. In other words, any data, records, fields, and/or intermediate results discussed in the method(s) can be stored, displayed and/or outputted to another device as required for a particular application. Furthermore, operations, steps, or blocks in FIG. 4 that recite a determining operation or involve a decision do not necessarily require that both branches of the determining operation be practiced. In other words, one of the branches of the determining operation can be deemed as an optional step. However, the use of the term “optional step” is intended to only reflect different variations of a particular illustrative embodiment and is not intended to indicate that steps not labelled as optional steps to be deemed to be essential steps. Furthermore, operations, steps or blocks of the above described method(s) can be combined, separated, and/or performed in a different order from that described above, without departing from the example embodiments of the present disclosure.

FIG. 5 depicts a high-level block diagram of a computing device or processing system specifically programmed to perform the functions described herein. For example, any one or more components or devices illustrated in FIG. 1 or described in connection with the method 400 may be implemented as the processing system 500. As depicted in FIG. 5, the processing system 500 comprises one or more hardware processor elements 502 (e.g., a microprocessor, a central processing unit (CPU) and the like), a memory 504, (e.g., random access memory (RAM), read only memory (ROM), a disk drive, an optical drive, a magnetic drive, and/or a Universal Serial Bus (USB) drive), a module 505 for providing a distributed database system with entry transactionality, and various input/output devices 506, e.g., a camera, a video camera, storage devices, including but not limited to, a tape drive, a floppy drive, a hard disk drive or a compact disk drive, a receiver, a transmitter, a speaker, a display, a speech synthesizer, an output port, and a user input device (such as a keyboard, a keypad, a mouse, and the like).

Although only one processor element is shown, it should be noted that the computing device may employ a plurality of processor elements. Furthermore, although only one computing device is shown in the Figure, if the method(s) as discussed above is implemented in a distributed or parallel manner for a particular illustrative example, i.e., the steps of the above method(s) or the entire method(s) are implemented across multiple or parallel computing devices, e.g., a processing system, then the computing device of this Figure is intended to represent each of those multiple computers. Furthermore, one or more hardware processors can be utilized in supporting a virtualized or shared computing environment. The virtualized computing environment may support one or more virtual machines representing computers, servers, or other computing devices. In such virtualized virtual machines, hardware components such as hardware processors and computer-readable storage devices may be virtualized or logically represented. The hardware processor 502 can also be configured or programmed to cause other devices to perform one or more operations as discussed above. In other words, the hardware processor 502 may serve the function of a central controller directing other devices to perform the one or more operations as discussed above.

It should be noted that the present disclosure can be implemented in software and/or in a combination of software and hardware, e.g., using application specific integrated circuits (ASIC), a programmable logic array (PLA), including a field-programmable gate array (FPGA), or a state machine deployed on a hardware device, a computing device, or any other hardware equivalents, e.g., computer readable instructions pertaining to the method(s) discussed above can be used to configure a hardware processor to perform the steps, functions and/or operations of the above disclosed method(s). In one example, instructions and data for the present module or process 505 for providing a distributed database system with entry transactionality (e.g., a software program comprising computer-executable instructions) can be loaded into memory 504 and executed by hardware processor element 502 to implement the steps, functions or operations as discussed above in connection with the example method 400. Furthermore, when a hardware processor executes instructions to perform “operations,” this could include the hardware processor performing the operations directly and/or facilitating, directing, or cooperating with another hardware device or component (e.g., a co-processor and the like) to perform the operations.

The processor executing the computer readable or software instructions relating to the above described method(s) can be perceived as a programmed processor or a specialized processor. As such, the present module 505 for providing a distributed database system with entry transactionality (including associated data structures) of the present disclosure can be stored on a tangible or physical (broadly non-transitory) computer-readable storage device or medium, e.g., volatile memory, non-volatile memory, ROM memory, RAM memory, magnetic or optical drive, device or diskette and the like. Furthermore, a “tangible” computer-readable storage device or medium comprises a physical device, a hardware device, or a device that is discernible by the touch. More specifically, the computer-readable storage device may comprise any physical devices that provide the ability to store information such as data and/or instructions to be accessed by a processor or a computing device such as a computer or an application server.

While various embodiments have been described above, it should be understood that they have been presented by way of example only, and not limitation. Thus, the breadth and scope of a preferred embodiment should not be limited by any of the above-described example embodiments, but should be defined only in accordance with the following claims and their equivalents.

What is claimed is:

1. An apparatus comprising:
a processing system including at least one processor to provide:
a first instance of a database, wherein the first instance of the database is one of a plurality of instances of the database distributed at a plurality of different nodes; and
a first instance of a middleware module, wherein the first instance of the middleware module is one of a plurality of instances of the middleware module distributed at the plurality of different nodes, wherein the first instance of the middleware module is associated with the first instance of the database, wherein the first instance of the middleware module is configured to:
receive a request from a first client to perform a transaction relating to at least one range of keys of the database;
confirm an ownership of the first client of the at least one range of keys;
execute one or more operations of the transaction over the first instance of the database that is associated with the first instance of the middleware module; and
write at least a first entry to a first instance of an entry consistent store, the at least the first entry recording at least one change of at least one value in the database resulting from executing the one or more operations of the transaction.

2. The apparatus of claim 1, wherein the plurality of different nodes is distributed at a plurality of different sites.

3. The apparatus of claim 1, wherein the first instance of the middleware module is further configured to:
restrict changes to values in the database associated with the at least one range of keys to the first client having the ownership of the at least one range of keys.

4. The apparatus of claim 1, wherein each of the plurality of instances of the middleware module is configured to:
prevent changes to values in the database associated with the at least one range of keys by clients other than the first client having the ownership of the at least one range of keys.

5. The apparatus of claim 1, wherein the first instance of the middleware module is further configured to maintain sequential consistency of operations with respect to the at least one range of keys within the first instance of the database that is associated with the first instance of the middleware module.

6. The apparatus of claim 1, wherein the first instance of the entry consistent store is one of a plurality of instances of the entry consistent store.

7. The apparatus of claim 6, wherein the plurality of instances of the entry consistent store maintains entries comprising changes in values in the database resulting from execution of operations of transactions via a plurality of middleware modules.

8. The apparatus of claim 1, wherein the first instance of the middleware module is further configured to:
obtain a notification of an ownership change of at least a portion of the at least one range of keys; and
prevent changes to values in the database associated with the at least the portion of the at least one range of keys by the first client and by any additional clients not having an ownership of the at least the portion of the at least one range of keys.

9. The apparatus of claim 8, wherein the notification of the ownership change is obtained from a different one of the plurality of instances of the middleware module.

10. The apparatus of claim 1, wherein the database comprises a structured query language database.

11. The apparatus of claim 1, wherein the database comprises a plurality of rows, wherein each row comprises a key and a value.

12. The apparatus of claim 11, wherein the value of each row comprises one or more fields, wherein each of the one or more fields is selectable via a structured query.

13. The apparatus of claim 1, wherein the at least one range of keys is associated with at least one partition of the database.

14. The apparatus of claim 1, wherein the first instance of the middleware module is further configured to, prior to the executing the one or more operations of the transaction over the first instance of the database:
obtain at least a second entry relating to the at least one range of keys from the first instance of the entry consistent store, in response to receiving the request from the first client to perform the transaction relating to the at least one range of keys; and
update at least one value associated with at least one key in the at least one range of keys over the first instance of the database that is associated with the first instance of the middleware module, in accordance with the second entry.

15. The apparatus of claim 1, wherein the first client is one of a plurality of clients that is permitted to access the database, wherein the plurality of clients comprises a plurality of federated software defined network controllers.

16. The apparatus of claim 1, wherein the database stores information associated with a plurality of virtual network functions of a telecommunication network.

17. The apparatus of claim 1, wherein the processing system further includes at least one storage device, to store the first instance of the database.

18. The apparatus of claim 1, wherein the processing system further includes at least one memory unit, to provide the first instance of the entry consistent store.

19. A method comprising:
receiving, by a processing system including at least one processor, a request from a first client to perform a transaction relating to at least one range of keys of a database, wherein the processing system comprises a first instance of a middleware module, wherein the first instance of the middleware module is one of a plurality of instances of the middleware module distributed at a plurality of different nodes, wherein the first instance of the middleware module is associated with a first instance of the database, wherein the first instance of the database is one of a plurality of instances of the database distributed at the plurality of different nodes;
confirming, by the processing system, an ownership of the first client of the at least one range of keys;
executing, by the processing system, one or more operations of the transaction over the first instance of the database that is associated with the first instance of the middleware module; and
writing, by the processing system, at least a first entry to a first instance of an entry consistent store, the at least the first entry recording at least one change of at least one value in the database resulting from executing the one or more operations of the transaction.

20. A non-transitory computer-readable medium storing instructions which, when executed by a processing system including at least one processor, cause the processing system to perform operations, the operations comprising:
receiving a request from a first client to perform a transaction relating to at least one range of keys of a database, wherein the processing system comprises a first instance of a middleware module, wherein the first instance of the middleware module is one of a plurality of instances of the middleware module distributed at a plurality of different nodes, wherein the first instance of the middleware module is associated with a first instance of the database, wherein the first instance of the database is one of a plurality of instances of the database distributed at the plurality of different nodes;
confirming an ownership of the first client of the at least one range of keys;
executing one or more operations of the transaction over the first instance of the database that is associated with the first instance of the middleware module; and
writing at least a first entry to a first instance of an entry consistent store, the at least the first entry recording at least one change of at least one value in the database. resulting from executing the one or more operations of the transaction.
